(19) United States
(12) Patent Application Publication
(10) Pub. No.: US 2025/0284572 A1
(43) Pub. Date: Sep. 11, 2025

(54) DUAL-MICROPROCESSOR IN LOCK STEP WITH A TIME COUNTER FOR STATICALLY DISPATCHING INSTRUCTIONS

(71) Applicant: Simplex Micro, Inc., Austin, TX (US)

(72) Inventor: Thang Minh Tran, Austin, TX (US)

(73) Assignee: Simplex Micro, Inc., Austin, TX (US)

(21) Appl. No.: 19/074,788

(22) Filed: Mar. 10, 2025

Related U.S. Application Data
(60) Provisional application No. 63/563,900, filed on Mar. 11, 2024.

(51) Int. Cl. G06F 9/54; G06F 9/48

(52) U.S. Cl. CPC G06F 9/544; G06F 9/4837; G06F 2209/543

(57) ABSTRACT

A processing system includes a time counter, a block of memory and register files, a first processor core and a second processor core, and wherein the processor core includes a register scoreboard and provides a method for statically dispatching instructions with preset execution times based on a write time of a register in the register scoreboard and the time counter provided to an execution pipeline. The processing system also includes method for comparing and validating the functional safety of the processor cores.

### RELATED APPLICATIONS

This application claims priority to U.S. provisional patent application 63/563,900 filed on Mar. 11, 2024, entitled “Dual-Microprocessor In Lock Step With A Time Counter For Statically Dispatching Instructions,” which application is hereby incorporated by reference in its entirety. This application is related to U.S. Pat. No. 11,829,187, filed Jan. 30, 2022, and entitled “Microprocessor with Time Counter for Statically Dispatching Instructions,” which application is hereby incorporated by reference in its entirety, and this application is also related to U.S. Pat. No. 11,829,767, filed Feb. 15, 2022, and entitled “Register Scoreboard for A Microprocessor with a Time Counter for Statically Dispatching Instructions,” which application is hereby incorporated by reference in its entirety.

### BACKGROUND

### Technical Field

The present invention relates to the field of computer processors. More particularly, it relates to issuing and executing instructions based on a time count in a processor where the processor consists of a general-purpose microprocessor, a digital-signal processor, a single instruction multiple data processor, a vector processor, a graphics processor, or other type of microprocessor which executes instructions.

### Technical Background

A growing application for microprocessors is in automobiles especially with the recent innovations of smart cars and self-driving cars. A significant requirement for the automotive industry is the functional safety of the microprocessors. One method for functional safety is dual- core lock step where 2 cores are running in lock step and any deviation causes an error to restart the cores. The cores are mostly single or dual issue and in-order microprocessors. As the microprocessor becomes more complex and larger, it is much more costly to duplicate the cores to run in lock step.

There is therefore a need to build an OOO superscalar microprocessor to meet the functional safety requirement of, for example, the automotive industry. Furthermore, the extensible and scalable architecture of the superscalar microprocessor provides long term benefits.

### SUMMARY

The disclosed embodiments provide a register scoreboard for a processor with a time counter and a method of using the register scoreboard for statically dispatching instructions to an execution pipeline with preset execution times based on a time count from the counter. The time counter provides a time count representing a specified time of the processor and is incremented periodically. An instruction issue unit is coupled to the time counter and receives instructions, then issues those instructions with a preset execution time based on the time count. An execution queue also receives the time count and receives the instructions, then dispatches the instructions to a functional unit when the time count reaches the preset execution time.

In one embodiment, a time counter increments every clock cycle and the resulting count is used to statically schedule instruction execution. Instructions have known throughput and latency times, and thus can be scheduled for execution based on the time count. For example, an add instruction with throughput and latency time of 1 can be scheduled to execute when any data dependency is resolved. If the time count is 5 and the add has no data dependency at time 8, then the available read buses are scheduled to read data from the register file at time 8, the available arithmetic logic unit (ALU) is scheduled to execute the add instruction at time 9, and the available write bus is scheduled to write result data from ALU to the register file at time 9. The add instruction is dispatched to the ALU execution queue with the preset execution times. The read buses, the ALU, and the write bus are scheduled to be busy at the preset times. The maximum time count is designed to accommodate the largest future time to schedule execution of instruction. In some embodiments, the time count is 64 and no instruction can be scheduled to execute more than 64 cycles in the future.

Functional safety of a microprocessor includes 2 factors: (1) error-correcting code (ECC) memories (at least one-bit correction) and (2) reliability of the dual cores to each produce the same result on execution of every instruction. The ECC memories include the memory caches and a large register file that are shared between the dual cores. The dual cores use the same data read from the shared memories and compare the data written to the shared memories for correctness. The dual cores also compare PC, instructions, and architecture registers at various stages of the processor for functional safety. In OOO execution, the instruction can take hundreds of cycles to complete. providing the checkers at these additional stages can detect any discrepancy at a much earlier time. The time count ensures that the instructions are executed at the exact cycle between the cores.

### BRIEF DESCRIPTION OF THE DRAWINGS

Aspects of the present invention are best understood from the following description when read with the accompanying figures.

FIG. 1 is a block diagram illustrating a processor based data processing system in accordance with a preferred embodiment of the present invention;

FIG. 2 is a block diagram illustrating dual cores with comparators for error detection;

FIG. 3 is a block diagram illustrating a register file and a register scoreboard;

FIG. 4 is a block diagram illustrating a time-resource matrix;

FIGS. 5A and 5B are block diagrams illustrating operation of a read control unit and a write control unit; and

FIG. 6 is a block diagram illustrating an execution queue.

### DETAILED DESCRIPTION

The following description provides different embodiments for implementing aspects of the present invention. Specific examples of components and arrangements are described below to simplify the explanation. These are merely examples and are not intended to be limiting. For example, the description of a first component coupled to a second component includes embodiments in which the two components are directly connected, as well as embodiments in which an additional component is disposed between the first and second components. In addition, the present disclosure repeats reference numerals in various examples. This repetition is for the purpose of clarity and does not in itself require an identical relationship between the embodiments.

In one embodiment, a processor is provided, typically implemented as a microprocessor, that schedules instructions to be executed at a preset time based on a time count from a time counter. In such a microprocessor the instructions are scheduled to be executed using the known throughput and latency of each instruction to be executed. For example, in one embodiment, the ALU instructions have throughput and latency times of 1, the multiply instructions have a throughput time of 1 and a latency time of 2, the load instructions have a throughput time of 1 and a latency time of 3 (based on a data cache hit), and the divide instruction have throughput and latency times of 32.

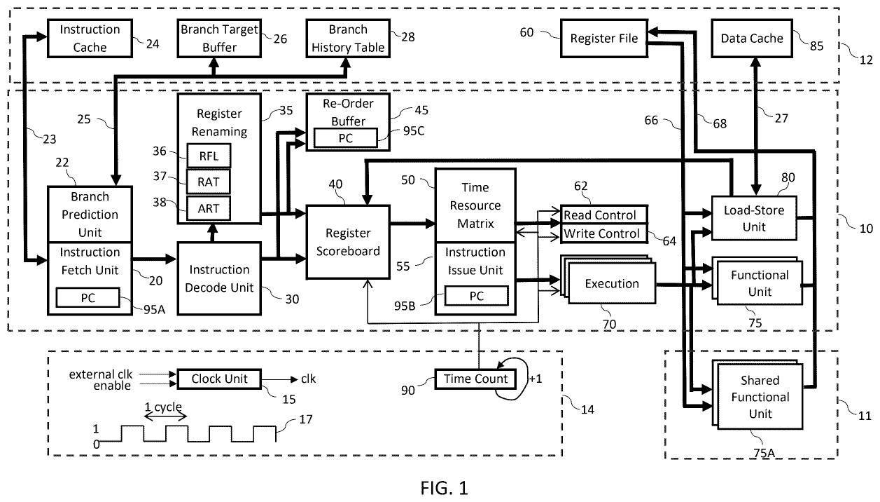

FIG. 1 is a block diagram of a microprocessor-based data processing system. The exemplary system includes a microprocessor core 10, a shared functional unit 11, a SRAM memory and register file block 12 and a clock module 14. The microprocessor core 10 includes instruction fetch unit 20, a branch prediction unit 22, an instruction decode unit 30, a register renaming unit 35, a register scoreboard 40, re-order buffer 45, a time-resource matrix 50, an instruction issue unit 55, a read control unit 62, a write control unit 64, a plurality of execution queues 70, a plurality of functional units 75, and a load-store unit 80. The units in microprocessor core 10 couple to the SRAM memories and register file block 12 which includes an instruction cache 24, a branch target buffer 26, a branch history table 28, a register file 60, and a data cache 85. The branch target buffer 26 and the branch history table 28 are caches implemented with SRAM memories. The plurality of execution queues 70 is coupled to the plurality of functional units 75, the load-store unit 80, and a plurality of shared functional units 75A which reside in the shared functional unit 11 logically separate from the microprocessor core 10. The shared functional units 75A typically include integer functional units which are small and can be duplicated per microprocessor core 10 in a dual-core system. The shared functional units 75A may also include floating point functional units which are much larger and can be shared by the processor cores of the dual-core system. The clock module 14 includes a clock unit 15, and a time counter unit 90 which stores a time count incremented, in one embodiment, every clock cycle. The time counter unit 90 is coupled to the clock unit 15 and uses “clk” signal to increment the time count. Microprocessor core 10 is a synchronous microprocessor where the clock unit 15 generates a clock signal (“clk”) which couples to all the units in the microprocessor core 10. The clock unit 15 provides a continuously toggling logic signal 17 which toggles between 0 and 1 repeatedly at a clock frequency. Clock output signal (“clk”) of clock unit 15 enables synchronization of the many different units and states in the microprocessor core 10. The clock signal is used to sequence data and instructions through the units that perform the various computations in the microprocessor core 10. The clock unit 15 may include an external clock as input to synchronize the microprocessor core 10 with external units (not shown). The clock unit 15 may further include an enable signal to disable the clock unit when the microprocessor is in idle stage or not used for instruction execution.

The microprocessor core 10 and the SRAM memories and register file 12 are coupled by a plurality of read buses 66 connecting the register file 60 to the functional units 75 and load-store unit 80, a plurality of write buses 68 to write result data from the functional units 75 and the load-store unit 80 to the register file 60, an instruction bus 23 coupling the instruction cache 24 and the instruction fetch unit 20, a plurality of branch prediction related buses 25 connecting the branch prediction unit 22 to the branch target buffer 26 and the global history table 28, and buses 27 for connecting the load-store unit 80 to the data cache 85. The SRAM memories and the register file 12 are designed with ECC memories and registers.

In one embodiment the time count represents the time in clock cycles when an instruction in the instruction issue unit 55 is scheduled for execution. For example, if the current time count is 5 and an instruction is scheduled to be executed later in 22 cycles, then the instruction is sent to the execution queue 70 with the execution time count of 27. When the time count increments to 26, the execution queue 70 issues the instruction to the functional unit 75 or the load-store unit 80 or the shared functional unit 75A for execution in the next cycle (time count 27). The time counter unit 90 is coupled to the register scoreboard 40, the time-resource matrix 50, the read control 62, the write control 64, and the plurality of execution queues 70.

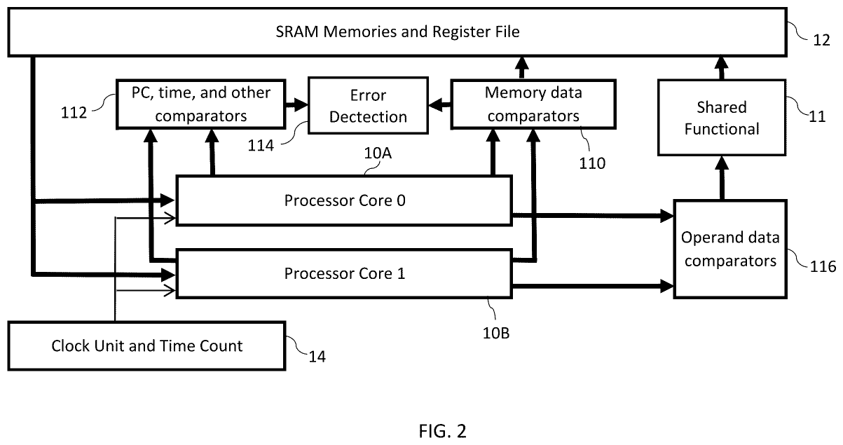

The register scoreboard 40 resolves data dependencies in the instructions. The time-resource matrix 50 checks availability of the various resources, which in one embodiment include the read buses 66, the functional units 75, the shared functional units 75A, the load-store unit 80, and the write buses 68. The read control unit 62, the write control unit 64, and the execution queues 70 receive the scheduled times for the instructions from the instruction issue unit 55. When an instruction is issued from the instruction issue unit 55 to the execution queue 70, the instruction is routed out of the processor core 10 for functional safety before the execution of the instruction, as described in further detail in connection with FIG. 2. The read control unit 62 is set to read the source operands from the register file 60 on specific read buses 66 at a preset time. The write control unit 64 writes the result data from a functional unit 75 or the load-store unit 80 or the data cache 85 to the register file 60 on a specific write bus 68 at a preset time. The execution queue 70 is set to dispatch an instruction to a functional unit 75 or the load-store unit 80 at a preset time. In each case, the preset time is the time determined by the instruction decode unit 30. The preset time is a future time that is based on the time count, so when the time count counts up to the preset time, then the specified action will happen. The specified action can be reading data from the register file, writing data to the register file, issuing an instruction to a functional unit for execution, or some other action. The instruction decode unit 30 determines when an instruction will be free of data dependencies and the resource will be available. This allows it to set the “preset time” for the instruction to be executed in the execution pipeline

In the microprocessor core 10, the instruction fetch unit 20 fetches the next instruction(s) from the instruction cache 24 to send to the instruction decode unit 30. In one embodiment, the microprocessor core 10 keeps the program counters (not shown) for instructions in the instruction fetch unit 20, in the instruction issue unit 55 as necessary for branch instructions, and in the re-order buffer 45 to retire instructions. The program counters at various stages of the microprocessor core 10 are routed out of the core to compare to the second core running in lock step. The program counter 95A in the instruction fetch unit 20 operates as a speculative program counter to fetch instructions. The program counter 95B which also operates as a speculative program counter is calculated in the instruction issue unit 55 to attach the branch instruction for calculation of the branch target address and to load and store instruction(s) for possibility of an exception. The program counter 95C in the re-order buffer 45 operates as the architectural program counter which is updated on retiring of an instruction or plurality of instructions. On branch misprediction or exception, the program counters 95A and 95B are set to be the same as program counter 95C. The instruction fetch unit 20 fetches the next instruction(s) from the instruction cache 24 to send to the instruction decode unit 30. The number of instructions per cycle can vary and is dependent on the number of instructions per cycle supported by the processor. One or more instructions can be fetched per clock cycle by the instruction fetch unit depending on the configuration of microprocessor core 10. For higher performance, microprocessor core 10 fetches more instructions per clock cycle for the instruction decode unit 30. For low-power and embedded applications, microprocessor core 10 might fetch only a single instruction per clock cycle for the instruction decode unit 30. If the instructions are not in the instruction cache 24 (commonly referred to as an instruction cache miss), then the instruction fetch unit 20 sends a request to external memory (not shown) to fetch the required instructions. The external memory may consist of hierarchical memory subsystems, for example, an L2 cache, an L3 cache, read-only memory (ROM), dynamic random-access memory (DRAM), flash memory, or a disk drive. The external memory is accessible by both the instruction cache 24 and the data cache 85. The instruction fetch unit 20 is also coupled to the branch prediction unit 22 for prediction of the next instruction address when a branch is detected and predicted by the branch prediction unit 22. As the branch is executed and mispredicted in the branch execution unit, which is one of the functional units 75, the branch result is written into the branch target buffer 26 and the branch history table 28 for future prediction of the same branch by the branch prediction unit 22. The instruction fetch unit 20, the instruction cache 24, the branch prediction unit 22, the branch target buffer 26, and the branch history table 28 are described here for completeness of a microprocessor core 10. In other embodiments, other instruction fetch, and branch prediction methods can be used to supply instructions to the instruction decode unit 30 for microprocessor core 10.

The instruction decode unit 30 is coupled to the instruction fetch unit 20 for new instructions and also coupled to the register renaming unit 35 and the register scoreboard 40. The instruction decode unit 30 decodes the instructions for instruction type, instruction throughput and latency times, and the register operands. The register operands, for example, may consist of 2 source operands and 1 destination operand. The operands are referenced to registers in the register file 60. The source and destination registers are used here to represent the source and destination operands of the instruction. The source registers support solving read-after-write (RAW) data dependencies. If a later instruction has the same source register as the destination register of an carlier instruction, then the later instruction has RAW data dependency. The later instruction must wait for completion of the earlier instruction before it can start execution.

Other data dependencies for the instructions include the write-after-write (WAW) and write-after-read (WAR). The WAW data dependency occurs when 2 instructions write back to the same destination register. The WAW dependency restricts the later instruction from writing back to the same destination register before the earlier instruction is written to it. To address the WAW dependency, every destination register is renamed by the register renaming unit 35 where the later instruction is written to a different register from the earlier register, thus eliminating the WAW data dependency. For example, if three instructions have the same destination register R5, and which are renamed to R37, R68, R74 then the three instructions can write to the destination register at any time. Without renaming, all three instructions will try to write to the same register R5 which is a WAW dependency in that the third instruction cannot write to R5 before the second instruction, which cannot write to R5 before the first instruction.

The register renaming unit 35 also eliminates the WAR data dependency where the later instruction cannot write to a register until the earlier instruction reads the same register. Since the destination register of the later instruction is renamed, the earlier instruction can read the register at any time. In such an embodiment, as the destination registers are renamed, the instructions are executed out-of-order and written back to the renamed destination register out-of-order. The register scoreboard 40 is used to keep track of the completion time of all destination registers. In a preferred embodiment the completion time is maintained in reference to the time count 90.

In one embodiment, the register renaming unit 35 consists of a register free list (RFL) 36, a register alias table (RAT) 37, and an architectural register table (ART) 38. In one embodiment, the 32-entry architectural registers have 96 temporary registers for renaming, for a total of 128 physical registers, referred to as the register file 60. The architectural registers are mapped into the physical register file 60 in which the issue and execute pipelines of the microprocessor core 10 are used to execute instructions based on the registers in register file 60. In the above-described embodiment, register scoreboard 40 keeps the write back time for the 128 physical registers. The register scoreboard 40 is associated with the physical register file 60. The RFL 36 keeps track of temporary registers (96 registers in this example) which have not been used. As the destination register of an instruction is renamed, a register on the free-list is used for renaming. The register alias table 37 stores the latest renamed registers of the architectural registers. For example, if register R5 is renamed to the temporary register R52, then the register alias table 37 keeps the renaming of R5 to R52. Thus, any source operand which references to R5 will see R52 instead of R5. As the architectural register R5 is renamed to R52, eventually when register R52 is retired, the architectural register R5 becomes R52 as stored in the architectural register table 38. The RAT 37 keeps track of the architectural register which will eventually retire to the architectural register table 38. The register scoreboard 40 indicates the earliest time for availability of a source register of the register file 60.

In one embodiment, if instructions are executed out-of-order, then the re-order buffer 45 is needed to ensure correct program execution. The register renaming unit 35 and the instruction decode unit 30 are coupled to the re-order buffer 45 to provide the order of issued instructions and the latest renaming of all architectural registers. The re-order buffer 45 is needed to retire the instructions in order regardless of when the instructions are executed and written back to the register file 60. In one embodiment, re-order buffer 45 takes the form of a first in first out (FIFO) buffer. Inputs are instructions from the instruction decode unit 30 and instructions are retired in order after completion by the functional unit 75 or the load-store unit 80. In particular, the re-order buffer 45 flushes all instructions after a branch misprediction or instruction exception. The ART 38 is updated only with the instructions before a branch misprediction or instruction exception. Another function of the re-order buffer 45 is writing data to memory only in accordance with the order of the load and store execution. The data memory (including data cache 85 and external memory) should be written in order by retiring of the store instructions from the re-order buffer 45. Retiring of store instructions is performed in order, so the store buffer (not shown) in the load-store unit 80 writes data to data memory only when the store instruction is retired by the re-order buffer 45. Retiring of an architectural register from the re-order buffer 45 to the ART 38 should be routed out of the microprocessor core 10 to be compared to the second core for functional safety, as described in further connection with FIG. 2.

Each of the units shown in the block diagram of FIG. 1 can be implemented in integrated circuit form by one of ordinary skill in the art in view of the present disclosure. With regard to one embodiment of this invention, time counter 90 is a basic N-bit wrap-around counter incrementing by 1 every clock cycle. The time-resource matrix 50 is preferably implemented as registers with entries read and written as with a conventional register structure.

The integrated circuitry employed to implement the units shown in the block diagram of FIG. 1 may be expressed in various forms including as a netlist which takes the form of a listing of the electronic components in a circuit and the list of nodes that each component is connected to. Such a netlist may be provided via an article of manufacture as described below.

In other embodiments, the units shown in the block diagram of FIG. 1 can be implemented as software representations, for example in a hardware description language (such as for example Verilog) that describes the functions performed by the units of FIG. 1 at a Register Transfer Level (RTL) type description. The software representations can be implemented employing computer-executable instructions, such as those included in program modules and/or code segments, being executed in a computing system on a target real or virtual processor. Generally, program modules and code segments include routines, programs, libraries, objects, classes. components, data structures, etc. that perform particular tasks or implement particular abstract data types. The program modules and/or code segments may be obtained from another computer system, such as via the Internet, by downloading the program modules from the other computer system for execution on one or more different computer systems The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a non-transitory computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The aforementioned implementations of software executed on a general-purpose, or special purpose, computing system may take the form of a computer-implemented method for implementing a microprocessor, and also as a computer program product for implementing a microprocessor, where the computer program product is stored on a non-transitory computer readable storage medium and include instructions for causing the computer system to execute a method. The aforementioned program modules and/or code segments may be executed on suitable computing system to perform the functions disclosed herein. Such a computing system will typically include one or more processing units. memory and non-transitory storage to execute computer-executable instructions.

FIG. 2 is a block diagram of a dual-core processor operating in lock step. The exemplary system includes the SRAM memories and register file block 12, 2 processor cores 10A and 10B, the clock unit and time count module 14, the shared functional units 11, program counter (PC), time, and other comparators 112, memory-data comparators 110, and an error detection module 114. The SRAM memories and register file block 12, 2 processor cores 10A and 10B, and the clock unit and time count module 14 are as described in reference to FIG. 1. The time count 90 is shared by both processor cores 10A and 10B to ensure that instructions from both cores are issued to be executed at the same time count. Both cores request memory accesses at the same time. For the shared functional units 11, the source operand data from the processor cores 10A and 10B are compared by the operand data comparators 116 before sending to the shared functional units 11. The result data of the shared functional units 11 are written directly to the register file 60. The write accesses to the SRAM memories and register file 12 include address, control signals, and write data from processor core 0 10A and processor core 1 10B are compared by the memory-data comparators 110 and flag any difference to the error detection module 114. The SRAM memories and register file 12 receive the accessed data from the processor cores 10A/10B. In addition, the PC and other comparators 112 receive PC, execution times, instructions, and retired architectural registers from the processor cores 10A/10B in various pipeline stages of the processor cores 10A and 10B for lock step comparison where a discrepancy is reported to the error detection. Note that the instruction address that is sent from the instruction fetch unit 20 to the instruction cache 24, and the load and store addresses sent from the load-store unit 80 to data cache 85 are checked by the memory data comparators 110.

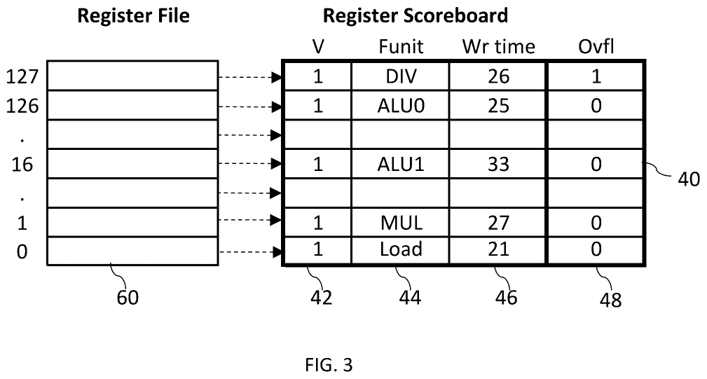

FIG. 3 illustrates further details of the register file 60 and the register scoreboard 40. In one embodiment, the register file 60 has 128 registers, numbered as registers 0 to 127 as illustrated. The register file 60 consists of all physical registers of the processor core 10. Each register in the register file 60 has a corresponding entry in the register scoreboard 40. The register scoreboard 40 stores the pending write status for the registers 60. A valid bit field 42 indicates a valid write back to the register file 60 at a future time in reference to the time count 90, as specified by the write time field 46 from a specific functional unit in the “Funit” field 44. As examples, illustrated in FIG. 3, register 0 is written back at time count 21 from the load-store unit 80. Register 1 is written back at time count 27 from the multiply unit (one of the functional units 75). Register 16 is written back at time count 33 from the ALUI, (another of the functional units 75), etc. The write time 46 is the time in reference to the time count 90. The result data is written to the register file 60. The data is not available from the register file 60 until the next clock cycle, but the result data can be forwarded from the corresponding functional unit 44 in the register scoreboard 40. For example, if the value of the time count 90 is 19, then the load-store unit 80 produces the result data in 2 clock cycles at time count 21 for writing back to the register file 60.

The write back time from a functional unit is based on the known latency time of an instruction. The latency time of a load instruction is not fixed. The latency time of a load instruction can be unpredictable as the load data may not be in the data cache 85. For a data cache miss, the data must be fetched from external memory as described above. In such a situation, the write back time in the scoreboard 40 for the destination register of a load instruction will no be longer correct. If processor core 10 is implemented with a level 2 cache (not shown), then the latency time for a level 2 cache hit can be used to update the register scoreboard 40.

The write time of a destination register is the read time for the subsequent instruction with RAW data dependency on the same destination register. Referring back to FIG. 1, the source registers of an instruction in the instruction decode unit 30 access the register scoreboard 40 for the corresponding read times. If the valid bit 42 of a source register is not set in the register scoreboard 40, then the data in the register file 60 can be accessed at any time providing availability of the read buses 66, otherwise the write time 46 is the earliest time to issue the instruction. The write time 46 is when the result data from the functional unit 75 or the load-store unit 80 are on the write bus 68 to the register file 60. The result data from write bus 68 can be forwarded to read bus 66 so that the result data is available on the read bus 66 in the same clock cycle in which it is written to the register file 60. In one embodiment, the “Funit” field 44 indicates which functional unit will write back to the register file 60, and the designated functional unit can restrict the aforementioned forwarding to the read bus 66 due to the presence of a critical timing path. For example, the data from the data cache is a critical timing path in which case forwarding is performed, in one embodiment, to only the ALUs. If the issued instruction is multiply, then the write time 46 from load-store unit 80 should be incremented by 1 to be used as the read time for the multiply instruction. In such an instance, the multiply instruction reads the data from the register file 60 one cycle after the load data is written to the register file 60. Forwarding of data from the load-store unit 80 to the ALU is normal and is the same as forwarding of any functional unit to any functional unit, while forwarding of data from the load-store unit 80 to a multiply unit is not allowed. As an example, when an instruction for the ALU reads the register 0 of the register scoreboard 40 in FIG. 3, the write time 46 of 21 is used as the read time as data can be forwarded from the load-store unit 80 onto read bus 66. When the multiply instruction reads the same register 0 of the register scoreboard 40 in FIG. 3, the read time of 22 is used to read data from the register file 60 as the data from the load-store unit 80 are written into the register file 60 in cycle 21. This same restriction is kept and does not permit the read control unit 62 to forward the load data from the load-store unit 80 to the multiply unit.

An instruction reads source operand data at read time, executes the instruction with a functional unit 75 at execute time, and writes the result data back to the register file 60 at write time. The write time is recorded in the write time field 46 of the register scoreboard 40. With 2 source registers, a given instruction selects the later write time, of the two source registers, from the register scoreboard 40 as the read time for the instruction. The execute time is the read time plus 1 time count where the functional unit 75 or the load-store unit 80 starts executing the instruction. The write time of the instruction is the read time plus the instruction latency time. If the instruction latency time is 1 (e.g., an ALU instruction), then the write time and execution time of the instruction are the same.

Each instruction has an execution latency time. For example, the add instruction has a latency time of 1, the multiply instruction has a latency time of 2, and the load instruction has a latency time of 3 assuming a data cache hit. In another example, if the current time count is 5 and the source registers of an add instruction receive write time counts of 22 and 24 from the register scoreboard 40, then the read time count is set at 24. In this case, the execution and the write time counts are both 25 for the add instruction. As shown in FIG. 1, the register scoreboard 40 is coupled to the time-resource matrix 50 where the read, execute, and write times of an instruction access the time-resource matrix 50 to determine availability of the resources.

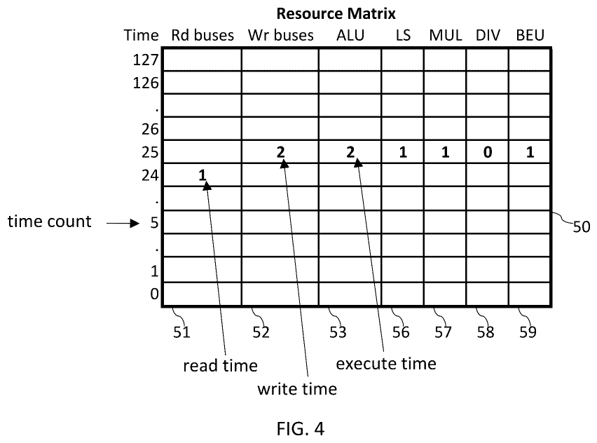

FIG. 4 illustrates further details of the time-resource matrix 50. The time-resource matrix 50 preferably includes the same number of time entries to match the time counter 90. For example, if the time counter 90 is 64 cycles, then the time-resource matrix 50 has 64 entries. In one embodiment, the time counter is incremented every clock cycle and rotates back from the 63rd entry to the 0th entry. The columns in the time-resource matrix 50 represent the available resources for the read buses 51, the write buses 52, the ALUs 53, the load-store ports 56, the multiply unit 57, the divide unit 58, and the branch execution unit (BEU) 59. If other functional units are provided by microprocessor core 10 those are also included in the resource matrix 50.

The read buses column 51 corresponds to the plurality of read buses 66 in FIG. 1. The write buses column 52 corresponds to the plurality of write buses 68 in FIG. 1. The ALUs column 53, the multiply column 57, the divide column 58, and the branch execution unit column 59 correspond to the plurality of functional units 75 of FIG. 1. The load-port ports column 56 corresponds to the load-store unit 80 of FIG. 1.

FIG. 4 also shows an example of the information in the time-resource matrix 50. Shown is data with a read time count of 24, an execution time count of 25, and a write time count of 25. When an instruction accesses the time-resource matrix 50 for availability of resources, the matrix 50 shows that at read time 24, there is 1 available read bus, and at execution time 25, there are 2 available ALUs, 1 load-store port, 1 multiply unit, and 1 BEU for execution of instruction. At write time 25, there are 2 available write buses. In another embodiment the matrix 50 may contain the number of utilized resources.

All available resources for a required time are read from the time-resource matrix 50 and sent to the instruction issue unit 55 for a decision of when to issue an instruction to the execution queue 70. If the resources are available at the required times, then the instruction can be scheduled and sent to the execution queue 70. The issued instruction updates the register scoreboard 40 with the write time and updates the time-resource matrix 50 to correspondingly reduce the available resource values. All resources must be available at the required time counts for the instruction to be dispatched to the execution queue 70. If all resources are not available, then the required time counts are incremented by one, and the time-resource matrix is checked as soon as the same cycle or next cycle. The particular number of read buses 66, write buses 68, and functional units 75 in FIG. 1 is preferably chosen to minimize stalling of instructions in the instruction issue unit 55.

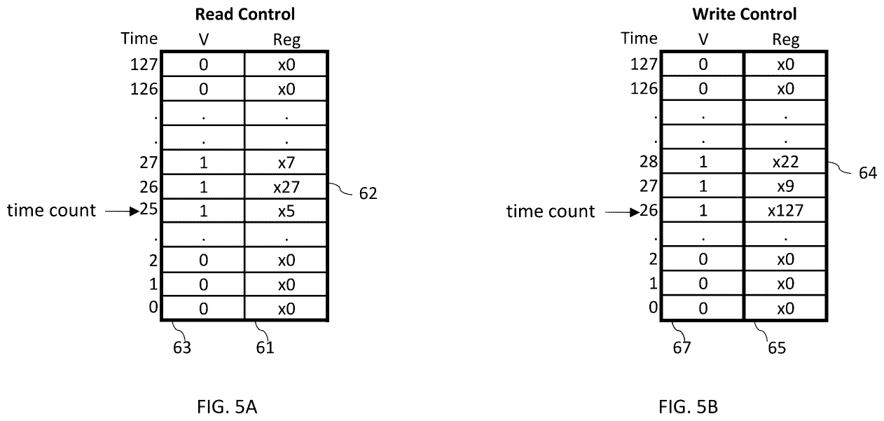

FIG. 5A illustrates a single read bus 66 represented in the read control unit 62 and FIG. 5B a single write bus 68 represented in the write control unit 64. The read control unit 62 and the write control unit 64 include a number of time entries to match the time counter 90. As mentioned above, in a preferred embodiment the time count is incremented every clock cycle. The columns shown in the read control unit 62 represent the source register 61 and a valid bit 63 for a read bus 66. The columns shown in the write control unit 64 represent the destination register 65 and a valid bit 67 for a write bus 68.

In the example illustrated in FIGS. 5A and 5B, at the time count of 25 in the read control unit 62 the register x5 from the register field 61 of the read control 62 is used to read the entry 5 from the register scoreboard 40 for the “Wr time” 46 and the “Funit” 44. If the write time 46 is the same as the time count 90, then the result data is written back to the register file 60 in the same clock cycle. The result data from the “Funit” 44 can be forwarded to the read bus 66 instead of being read from the register file 60. The write time 46 may have changed due to a cache miss of the load instruction, in which case the instruction cannot be executed yet because the source operand data is not valid. The RAW dependent instruction is rescheduled to be executed at later time. In the next cycle, when the time count is 26, the register x27 from the register field 61 is used to read from the register file 60. The read control unit 62 is responsible for supplying the source operand data on a specific one of the read buses 66. The execution queue 70 keeps the information of which one of the read buses 66 is to receive source operand data. The execution queues 70 and read control unit 62 are synchronized based on the time-resource matrix 50. The read control unit 62 provides centralized control for the read buses 66, thus reducing complexity from the hundreds of instructions in dynamic scheduling architectures.

Similarly in FIG. 5B, the register x5 from the register field 65 of the write control unit 64 at time count of 26 is used to write to the register file 60. The register x5 will also access the “Funit” 44 of the register scoreboard 40 to get the result data from a specific functional unit 75. Again, the execution queues 70, the functional units 75, and the write control unit 64 arc synchronized to transfer result data on a write bus 68 to write to the register file 60. In one embodiment, the write control unit 64 is in sync with the register scoreboard 42 where the time count entry valid bit 67 and the register 65 are used to clear the valid bit 42 in the register scoreboard 40 of FIG. 3 if the corresponding “Wr time” field 46 is the same as the time count 90. For example, at time count 26, the write valid bit is 1 and the write register which is x127 of write control unit 64 are sent to the register scoreboard 40 where the register x127 has the write time 46 of 26 which is the same as the time count and thus the valid bit 42 of the register x127 will be cleared. It is possible that the write time 46 of the register scoreboard 40 has been modified due to a delay in write time. An alternative is to compare time count to all “Wr time” fields 46 of the register scoreboard 40 and to clear the valid bit 42 for matching times. This alternative results in high power consumption if for example, there are 100 registers in the register scoreboard 40. The write control unit 64 operates as a centralized control for the write buses 68 which removes complexity compared to distributing such control among the plurality of functional units in dynamic scheduling.

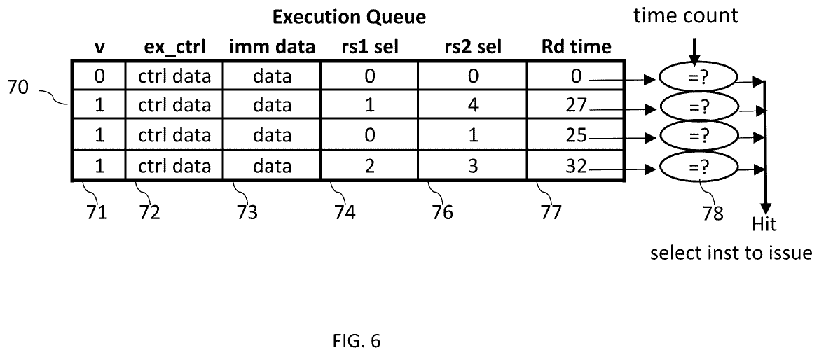

FIG. 6 illustrates an example of a 4-entry execution queue 70. The number of entries for the execution queue 70 is only an illustration. The invention is not limited to any number of execution queue 70 entries and the execution queue 70 could take the form of a single-entry execution queue. Each entry is an instruction waiting for execution by one of the functional units 75 or the load-store unit 80 according to the time count in the read time column 77. Each entry in the execution queue 70 preferably consists of the following fields: the valid bit 71, control data 72, the immediate data 73, the first source register select 74, the second source register select 76, and the read time 77. The valid bit 71, when set to “1,” indicates that the entry is valid in the execution queue 70. The control data 72 specifies the specific operation to be used by the functional units 75 or the load-store unit 80. The immediate data 73 is an alternative to the second source register for the instruction. The valid indication for the immediate data 73 may be included in the control data field 72. Most instructions have an option to use immediate data 73 instead of data from the second source register. The first source register select 74 identifies which one of the read buses 66 has the operand data for the first source register. The second source register select 76 identifies which one of the read buses 66 has the operand data for the second source register. The source register selects 74 and 76 may not be used for some instructions.

The read control 62 reads the register scoreboard 40 to ensure that the expected source operand data is still valid and is synchronized with the execution queue 70 to supply source data to the functional unit 75. If the write time 46 from the scoreboard 40 is modified to be greater than the time count 90, then the synchronized instruction in the execution queue 70 is replayed instead of going to the functional unit 75. In one embodiment, the replay instruction uses the new write time from the register scoreboard 40 to calculate the new read time, execution time, and write time for accessing the time resource matrix 50 to reissue the instruction. The procedure is the same as for instructions in the instruction issue unit 55. The read time 77 is unique to this architecture where the instructions are scheduled to deterministically to execute at a preset time. When the read time is written into the execution queue 70, then the read time should be compared in the PC, time, and other comparators 112 between the processor core 0 10A and the processor core 1 10B.

Note that the destination register can be, but does not need to be, kept with the instruction. The write control unit 64 is responsible for directing the result data from a functional unit 75 to a write bus 68 to write to the register file 60. The execution queues 70 are only responsible for sending instructions to the functional units 75 or the load-store unit 80. The read time field 77 which has the read time of the instruction is synchronized with the read control unit 62. When the read time 77 is the same as the time count 90 as detected by the comparators 78, the instruction is issued to the functional units 75 or the load-store unit 80. For the example in FIG. 6, the entries are issued to the functional units out-of-order. The read time field 77 indicates that the second entry is issued at time count 25, the third entry is issued at time count 27, and the first entry is issued at time count 32.

In an embodiment, each functional unit 75 has its own execution queue 70. In another embodiment, an execution queue 70 dispatches instructions to multiple functional units 75. In this case, another field (not shown) can be added to the execution queue 70 to indicate the functional unit number for dispatching of instructions.

Referring back to FIG. 1, the execution queues 70 are coupled to the load-store unit (LSU) 80 and the functional units 75. The execution queues 70 issue the instructions to the functional units 75 or the load-store unit 80 when the read times 77 are the same as the time count 90. If the instruction is a load-store, then it is dispatched to the LSU 80, else it is dispatched to one of the functional units 75. The LSU 80 and functional units 75 are also coupled to the read buses 66 and write buses 68 to access the register file 60. The source operand data are fetched from register file 60 and transported on read buses 66 to the LSU 80 and functional units 75. The result data from the LSU 80 and functional units 75 are transported on write buses 68 to write to destination registers in the register file 60. The LSU 80 is also coupled to the data cache 85. The LSU 80 executes the load and store instructions to read and write data from the data cache 85. If the data are not in the data cache 85, then the cache miss causes that cache line to be fetched from external memory (not shown). The load-store unit 80 receives data from the data cache 85 or external memory before sending load data to the register file 60 through the write bus 68. Typically, the functional units 75 perform different operations, e.g., ALU, multiply, divide, branch, etc. In other embodiments, the functional units 75 perform the same function, for example, multiple ALUs. Furthermore, the invention is not limited to integer functional units. In other embodiments the functional units include floating point units, digital-signal processing units, vector processing units, or custom designed units.

The foregoing explanation described features of several embodiments so that those skilled in the art may better understand the scope of the invention. Those skilled in the art will appreciate that they may readily use the present disclosure as a basis for designing or modifying other processes and structures for carrying out the same purposes and/or achieving the same advantages of the embodiments herein. Such equivalent constructions do not depart from the spirit and scope of the present disclosure. Numerous changes, substitutions and alterations may be made without departing from the spirit and scope of the present invention.

Although illustrative embodiments of the invention have been described in detail with reference to the accompanying drawings, it is to be understood that the invention is not limited to those precise embodiments, and that various changes and modifications can be affected therein by one skilled in the art without departing from the scope of the invention as defined by the appended claims.

What is claimed is:

1. A processing system comprising:
a time counter storing a time count representing a current time of the processor, wherein the time count is incremented periodically;
a block of memory and a register file;
a first processor core coupled to the time counter, the block of memory and the register file, the first processor core comprising a first instruction issue unit to receive a first instruction and dispatch the first instruction to a first functional unit based upon the time count;
a second processor core coupled to the time counter, the block of memory and the register file, the second processor core comprising a second instruction issue unit to receive the first instruction and dispatch the first instruction to a second functional unit based upon the time count; and
a plurality of comparators coupled to the first processor core and the second processor core to receive data from one or more corresponding stages of the first processor core and the second processor core and to validate data from the corresponding stages of the first processor core and the second processor core.

2. The processing system of claim 1 wherein:
the processing system includes a clock circuit, and the time counter increments the time count with each clock cycle of the processing system;
the first processor core and the second processor core each execute the first instruction according to a first preset execution time; and
the first preset execution time is correlated to the time count based upon the clock cycle.

3. The processing system of claim 2 wherein:
the time counter comprises an N-bit counter wherein an Nth-bit count value represents a largest future time for the first instruction issue unit and the second instruction issue unit to issue an instruction; and
the N-bit counter returns to a zero count after reaching the Nth-bit count value.

4. The processing system of claim 3 wherein:
the register file comprises,
registers for renaming all architectural registers of all threads supported by a corresponding processor; and
temporary registers;
the first processor core and the second processor core each comprise,
a register scoreboard storing a write time of a register in the register file, wherein the write time represents a future time relative to the time count;
an instruction decode unit coupled to the register scoreboard wherein the instruction decode unit reads write times for source operands of a particular instruction from the register scoreboard, and uses the write times to determine an execution time for the particular instruction;
a time-resource matrix coupled to the register scoreboard and the time counter for storing information relating to available resources of a corresponding processor core for at least some time counts of the N-bit time counter, and wherein the available resources include at least one of: a plurality of read buses, a plurality of write buses, and a plurality of functional units;
a read control unit storing with a corresponding time count entry a pointer entry to a register of the register file, and for each entry therein storing a forwarding valid bit to indicate when the corresponding entry may be read and transported on a read bus; and
a write control unit storing with a corresponding time count entry a pointer entry to a register of the register file to indicate when result data are transported from a write bus and written to a register of the register file;
wherein the first instruction issue unit and the second instruction issue unit are each coupled to a corresponding time-resource matrix to receive data therefrom and to issue a corresponding instruction if all resources indicated by the corresponding time-resource matrix are available, and to stall the corresponding instruction if any of the resources is not available.

5. The processing system of claim 3 wherein each processor core further comprises:
an execution queue that stores a plurality of instructions and a read time associated with each of the plurality of instructions, wherein the read time is a future time relative to the time count, and wherein the corresponding read control unit is synchronized with the read time in the execution queue.

6. The processing system of claim 5 wherein the execution queue dispatches instructions to at least one shared functional unit and wherein source operand data for the shared functional unit are compared before sending to the shared functional unit.

7. The processing system of claim 6 wherein the shared functional unit writes result data to the register files and to the block of memory.

8. The processing system of claim 1 wherein the comparators flag an error upon detection of a discrepancy between data from any of the corresponding stages of the first processor core and the second processor core.

9. The processing system of claim 8 wherein the comparators compares the following between the first processor core and the second processor core: program counters, execution times, instructions, and architectural registers.

10. The processing system of claim 1 wherein the comparators compare the following between the first processor core and the second processor core: memory data, control signals, and memory addresses.

11. The processing system of claim 1 wherein the memory is error-correcting code memory and the register file comprises a plurality of error-correcting code registers.

12. A processing system comprising:
a clock circuit;
a time counter storing a time count representing a current time of the processing system, wherein the time count is incremented with each cycle of the clock circuit;
a block of memory comprising cache memory and a register file;
a first processor core coupled to the time counter and block of memory and register file, the first processor core comprising a first instruction issue unit to receive a first instruction and dispatch the first instruction to a first functional unit based upon the time count;
a second processor core coupled to the time counter and block of memory and register file, the second processor core comprising a second instruction issue unit to receive the first instruction and dispatch the first instruction to a second functional unit based upon the time count;
a first plurality of comparators to validate one or more elements, program counters, execution times, instructions, and architectural registers from different stages of the first and second processor cores and report an error if a first discrepancy is detected; and
a second plurality of comparators to validate memory data, control signals, and memory addresses of the first and second processor cores and report an error if a second discrepancy is detected.

13. A method executed by a processing system, the method comprising:
issuing an instruction to a first execution queue in a first processor core to execute at a future time wherein the future time represents a time based on a time count from a time counter which is periodically incremented;
issuing the instruction to a second execution queue in a second processor core to execute at the future time; and
detecting if result data from the first and second processor cores are different.

14. The method of claim 13 wherein the time counter provides a maximum time count corresponding to a latest future time to issue an instruction.

15. The method of claim 14 further comprising:
storing a write time of a register of a register file wherein the write time represents a future time based on the time count wherein the register file performs renaming of architectural registers of all thread and temporary registers;
storing information corresponding to available resources for each time count in a time-resource matrix, wherein the resources comprise at least one of a plurality of read buses, a plurality of write buses, and a plurality of functional units;
storing a pointer to a first register of the register file in a read control unit, wherein the first register is read from the register file and transported on a read bus;
storing a pointer to a second register of the register file in a write control unit wherein result data are transported from a write bus and written to the second register of the register file;
storing a plurality of instructions in an execution queue wherein each instruction includes a read time based specified by the time count; and
synchronizing the read time of the execution queue with a read control unit.

16. The method of claim 15, wherein the execution queue dispatches instructions to one of a plurality of shared functional units.

17. The method of claim 16 wherein the shared functional unit writes result data to the block of memory and the register file.

18. The method of claim 13 wherein detecting if result data from the first and second processor cores are different comprises employing comparators to compare program counters, execution times, instructions, and architectural registers from different stages of the first and second processor cores and providing an error signal if a discrepancy is detected.

19. The method of claim 13 wherein detecting if result data from the first and second processor cores are different comprises employing comparators to compare memory data, control signals, and memory addresses of the first and second processor cores and reporting an error signal if a discrepancy is detected.

20. The method of claim 17 wherein the memory comprises error-correcting code memory and the register file comprises error-correcting code registers.
